(19) United States
(12) Patent Application Publication
(10) Pub. No.: US 2008/0243368 A1
(43) Pub. Date: Oct. 2, 2008

(54) NAVIGATION APPARATUS

(75) Inventor: Yoshiki KURODA, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/059,712

(22) Filed: Mar. 31, 2008

(30) Foreign Application Priority Data
Mar. 29, 2007 (JP) 2007-86672

(51) Int. Cl. G01C 21/00

(52) U.S. Cl. 701/200

(57) ABSTRACT

A navigation apparatus executes a navigation operation using information obtained from a map database. The navigation apparatus has a basic function unit that performs processing related to the navigation operation, and a data access unit that, in response to a request from the basic function unit, acquires data including information requested by the basic function unit from the map database, performs conversion on the data acquired from the map database according to the format of the map database to obtain data in a prescribed data form that is not dependent on the format of the map database, and passes the data in the prescribed data form to the basic function unit.

### BACKGROUND OF THE INVENTION

1. Field of the Invention

The present invention relates to a navigation apparatus that performs map display, route searches, route guidance and the like using a map database.

2. Description of the Related Art

Vehicle navigation apparatuses that are currently widely used have a map database that gathers various types of information related to roads, background, facilities and the like, and access the map database and appropriately acquire required information in order to perform core operations such as map display, route searches, route guidance and the like. At present, there exist various types of map databases having different formats, with there being a significant difference, in particular, between the format of map databases used in Japan and those used overseas in regions including North America and Europe. In Japan, map databases in KIWI format aimed at standardization are widely prevalent. However, manufactures have been known to independently modify the specifications of map databases in KIWI format in order to provide additional functions. KIWI format specifications differ between Japan and overseas. Differences in the format of loaded map databases often result in functional differences between navigation apparatuses.

Given the above situation, manufactures of vehicle navigation apparatuses needed to create computer programs (hereinafter, “core software”) defining the procedures for operations such as map display, route searches, and route guidance for each map database with a different format, in order to provide products to the market that were compatible with the various formats (or specifications) of map databases. Manufactures of vehicle navigation apparatuses expended a great deal of energy on firstly creating core software that was compatible with the format of a given map database, and then modifying this core software to make it compatible with other formats.

A navigation apparatus having a map database format substitution function has been proposed, in order to reduce the energy that navigation apparatus manufactures expend on software development. This navigation apparatus performs format substitution processing on a provided map database, and stores the map database in the substituted format on a recording medium. The navigation apparatus then accesses the map database in the substituted format to perform map display, route searches, route guidance or the like.

A navigation apparatus having such a configuration needs to store both the provided map database and the map database after format substitution on a rewritable recording medium such as a hard disk. When a plurality or map databases are thus stored on a recording medium, it is necessary that the recording capacity of the recording medium is secured for a map database that will not used after substitution. Further, given the increased capacity of map databases used in vehicle navigation apparatuses in recent years, a recording medium with a large recording capacity is required, leading to an increase in the cost of navigation apparatuses. While substitute map databases can conceivably be stored on a separate recording medium such as a DVD or a CD-ROM, a drive apparatus or the like for accessing this recording medium needs to be provided in the navigation apparatus in this case. Employing such a configuration is not desirable with small, portable navigation apparatuses.

In the case where a manufacturer produces a plurality of navigation apparatuses respectively loaded with map databases having different formats, only the core program need be changed according to the format if all of the map databases cover the same region (e.g. Japan). However, in the case where a manufacturer produces a plurality of navigation apparatuses respectively loaded with map databases covering different regions (e.g., map databases for Japan, Europe and North America), the core software also needs to be changed to take account of regional differences related to traffic systems and the like.

The present invention solves the above problems, and provides a navigation apparatus that operates without needing to change the core software even where the format of a loaded database changes or where the region covered by a loaded database changes.

### SUMMARY OF THE INVENTION

A navigation apparatus of the present invention executes a navigation operation using information obtained from a map database. The navigation apparatus has a basic function unit that performs processing related to the navigation operation, and a data access unit that, in response to a request from the basic function unit, acquires data including information requested by the basic function unit from the map database, performs conversion on the data acquired from the map database according to the format of the map database to obtain data in a prescribed data form that is not dependent on the format of the map database, and passes the data in the prescribed data form to the basic function unit.

In the navigation apparatus of the present invention, the data access unit may include a plurality of data conversion units that correspond one-to-one with a plurality of different formats, determine the format of the map database, converts the acquired data using the data conversion unit corresponding to the determined format to obtain the data in the prescribed data form, and passes the data in the prescribed data form to the basic function unit. Also, in the navigation apparatus of the present invention, the data access unit may perform merge processing on information included in the acquired data.

In the present invention, a basic function unit, or core program, that performs processing related to a navigation operation, does not need to be changed according to the format type of a map database loaded in the navigation apparatus, given that the form of data received by the basic function unit from the data access unit is the same even if the format of the loaded map database changes. Hence, according to the present invention, a plurality of navigation apparatuses respectively loaded with map databases having different formats is obtained without needing to change the core software, and moreover, a navigation apparatus is obtained that operates even when a map database is replaced by another map database with a different format.

In the present invention, the navigation apparatus, unlike the prior art, does not need to hold both a format-converted map database and a map database for converting, given that the data access unit performs data acquisition, conversion, and transfer in response to a request from the basic function unit.

In the present invention, the data access unit may perform merge processing on information included in data acquired from a map database. Core software can thus be created so as to not be dependent on the region covered by a loaded map database.

### BRIEF DESCRIPTION OF THE DRAWINGS

FIG. 1 is a block diagram showing the configuration of a navigation apparatus constituting a preferred embodiment of the present invention.

FIG. 2 is an illustrative view showing an overview of application software in the navigation apparatus constituting the preferred embodiment of the present invention.

FIG. 3 is an illustrative view showing an overview of a map database loaded in the navigation apparatus constituting the preferred embodiment of the present invention.

FIG. 4 is an illustrative view showing, in detail, a data access unit of the application software in the navigation apparatus constituting the preferred embodiment of the present invention.

FIGS. 5A to 5D are illustrative views schematically showing exemplary data conversions in the data access unit of the application software in the navigation apparatus constituting the preferred embodiment of the present invention.

FIGS. 6A and 6B are illustrative views schematically showing exemplary merge processing in the data access unit of the application software in the navigation apparatus constituting the preferred embodiment of the present invention.

FIG. 7 is a flowchart showing an overview of processing performed as a result of executing the application software in the navigation apparatus constituting the preferred embodiment of the present invention.

### DESCRIPTION OF THE PREFERRED EMBODIMENTS

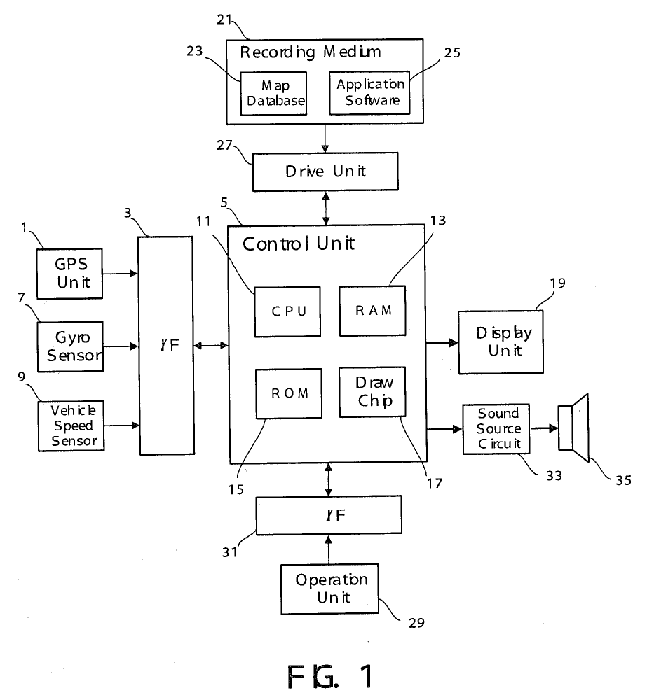

The present invention will now be described using the drawings. FIG. 1 is a block diagram showing the configuration of a navigation apparatus constituting a preferred embodiment of the present invention. The navigation apparatus of the present embodiment is for use in a vehicle, and primarily functions to guide the vehicle along a guidance or navigation route by specifying a position of the vehicle based on radio waves received from a global positioning system (GPS) satellite, and displaying the vehicle position together with a map of the vicinity thereof.

A GPS unit (1), which is constituted by a reception antenna, a tuner and the like, processes radio waves received from the GPS satellite and extracts positioning information. The extracted positioning information is sent to a control unit (5) via an interface (3). The control unit (5), which is constituted by a microcomputer, for example, specifies the current position of the vehicle based on the positioning information sent from the GPS unit (1). The navigation apparatus employs a so-called hybrid system, and is provided with a gyro sensor (7) for detecting the direction of travel of the vehicle, and a vehicle speed sensor (9) for detecting the speed of the vehicle. Based on signals from these sensors (7) and (9) sent via the interface (3), the control unit (5) specifies the direction of travel and speed of the vehicle.

The control unit (5) performs overall control of the navigation apparatus, and executes navigation operations such as map display, route searches, and route guidance. The control unit (5) is constituted by a microcomputer, for example, and includes a CPU (11) that executes various computer programs, a RAM (13) that temporarily stores data for use by the CPU (11) and programs read out from a recording medium (21) for execution by the CPU (11), a ROM (15) that stores font data and programs defining basic controls related to startup, input/output, and the like, and a draw chip (17) that creates image data such as maps and operation screens. The CPU (11) and other constituent elements are connected via a bus (not shown). A display unit (19) displays maps, operation screens and the like, based on image data created by the draw chip (17). An LCD, organic EL display or the like is used for the display unit (19).

The recording medium (21) stores a map database (23) related to various information required in navigation operations, and application software (application programs) (25) that includes core software defining navigation operations. The control unit (5) reads out application software (25) from the recording medium (21) via a drive unit (27), and executes the read application software (25). The control unit (5) extracts information required in navigation operations from the map database (23) via the drive unit (27). A hard disk, memory card, CD-ROM, DVD or the like is used for the recording medium (21).

An operation unit (29) is constituted by hardware keys, a touch panel, a remote controller and the like, and is used when a user performs inputs to the navigation apparatus. Signals notifying that the hardware keys or touch panel constituting the operation unit (29) have been pressed are sent to the control unit (5) via the interface (31). A sound source circuit (33) generates an analog audio signal for use in route guidance, based on audio data send from the control unit (5). The generated analog audio signal is reproduced by a speaker (35).

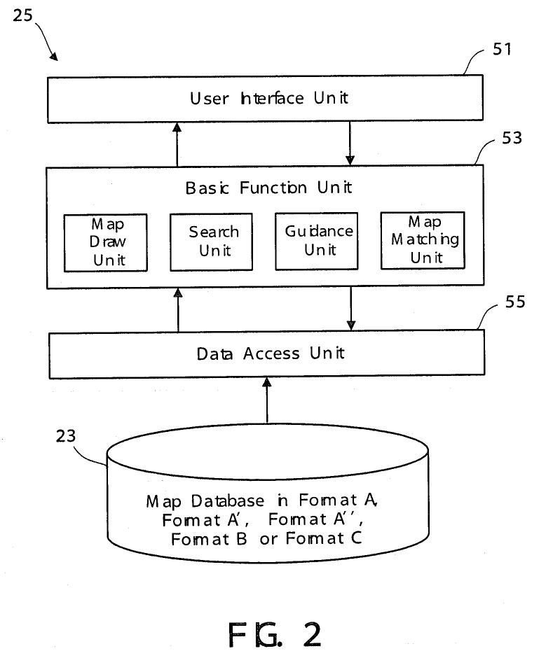

FIG. 2 is an illustrative view showing an overview of the application software (25) in the navigation apparatus of the present embodiment. The configuration shown in FIG. 1 functions as a navigation apparatus as a result of the application software (25) being read out from the recording medium (21) and executed by the control unit (5). A user interface (51), which realizes a function of transferring information between the user and the navigation apparatus, requests a basic function unit (53) to perform processing related to an operation designated by an input from the operation unit (29), and shows the processing result of the basic function unit (53) to the user via the display unit (19) and others. The basic function unit (53), which equates to the foregoing core software, includes a map draw unit that realizes a map draw function, a search unit that realizes a guidance route search function, a guidance unit that realizes a guidance function for displaying intersections, instructing right/left turns, and the like, and a map matching unit that realizes a function of computing the vehicle position from information obtained with the GPS unit (1) and the sensors (7) and (9), and displaying the vehicle position on a map.

The data access unit (55) realizes a function of acquiring information requested by the basic function unit (53) from the map database (23) in response to a request from the basic function unit (53), and passing the acquired information to the basic function unit (53). The navigation apparatus of the present embodiment is compatible with a plurality of map database formats. Specifically, the navigation apparatus operates regardless of whether the format of the map database (23) is format A, format A′, format A″, format B or format C. The basic function unit (53) and the data access unit (55) transfer requests and information therebetween via a common interface that is not dependent on the format of the map database (23).

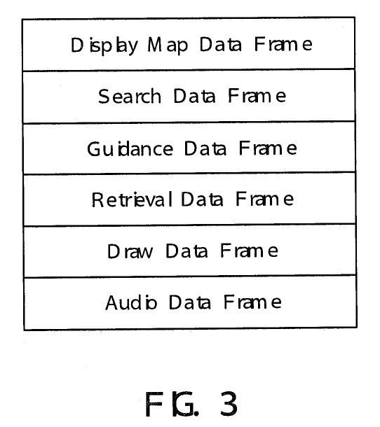

FIG. 3 is an illustrative view showing an overview of a map database in format A. The map database in format A is constituted by a display map data frame, a search data frame, a guidance data frame, a retrieval data frame, a draw data frame, an audio data frame, and the like. The display map data frame includes information for displaying a map showing roads, background, names, symbols, and the like, and is managed, for example, in defined areas called parcels. The search data frame includes information related to nodes, links, attributes, costs and the like of roads used in route searches. The guidance data frame includes various types of information for use in route guidance (e.g., intersection information). The retrieval data frame includes information used in retrieving points of interest, facilities and the like to set as the destination. The draw data frame includes image data used in drawing maps, guidance screens and the like, and the audio data frame includes audio data used in generating audio for use in guidance.

A map database in format B has a substantially similar configuration to FIG. 3, but the placement, type and the like of data in the data frames differ. For example, the retrieval data frame of the map database in format A has a hierarchal structure, whereas the retrieval data frame of the map database in format B has a relational structure.

Also, the map database in format A covers Japan, whereas the map database in format B covers North America, with there not only being a difference in format between these map databases, but also regional differences in information due to traffic systems, language and the like. For example, with the map database in format A for Japan, “kosokudoro” and “sharyosenyodoro” are included as the attributes of links, with these attributes normally showing (toll) roads on which vehicles travel faster than on normal roads. With the map database in format B for North America, the link attribute approximating or corresponding to the attributes “kosokudoro” and “sharyosenyodoro” in format A is “freeway.”

A map database in format A′ is obtained by modifying the map database in format A so as to cover North America, and a map database in format A″ is obtained by modifying the map database in format A so as to cover Europe. The map databases in formats A′ and A″ also have the configuration shown in FIG. 3, but an extension or the like for adding information corresponding to North America and Europe has been respectively added. The aforementioned regional differences in information also exist between the map databases in formats A, A′ and A″. The map database in format C corresponds to Europe, for example, and differs greater in comparison to the map databases in the aforementioned formats in that the display map data frame is not constituted by defined regions.

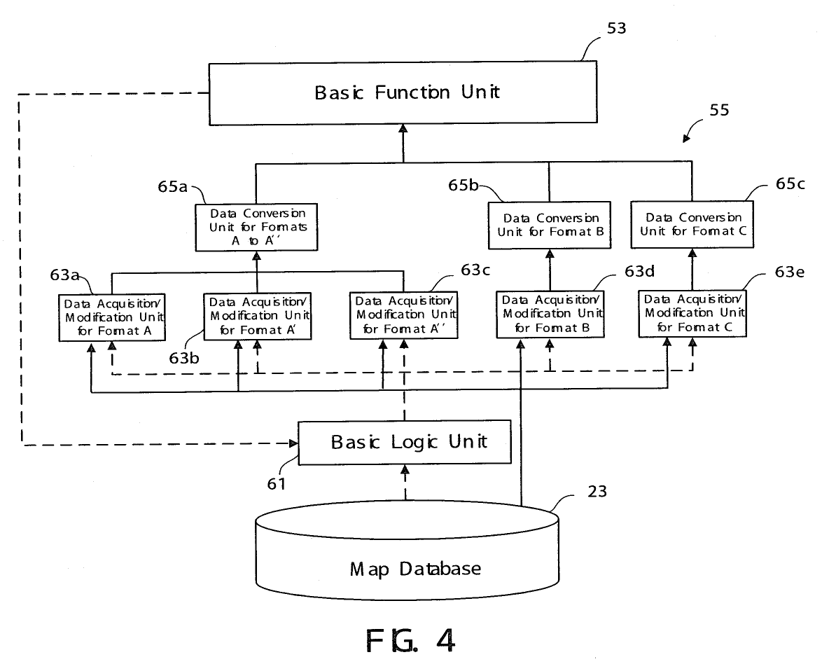

FIG. 4 is an illustrative view showing, in detail, the data access unit (55) shown in FIG. 2. The data access unit (55) includes a basic logic unit (61), and data acquisition/modification units (63a-63e) provided for each of the map database formats with which the navigation apparatus of the present embodiment is compatible. When there is an information acquisition request from the basic function unit (53), the basic logic unit (61) selectively uses one of the data acquisition/modification units (63a-63e) to extract data including the requested information from the map database (23). The basic logic unit (61) determines the format of the map database (23) stored in the recording medium (21), and requests the data acquisition/modification unit (63a-63e) corresponding to the determined format to extract data. The format is determined based on a format identifier included in the map database (23). For example, if the format of the map database (23) is format A, the data acquisition/modification unit (63a) for format A is used, and if the format of the map database (23) is format B, the data acquisition/modification unit (63d) for format B is used.

Information acquisition requests are sent from the basic function unit (53) to the basic logic unit (61) in a form (or format) that is not dependent on the format of the map database (23). For example, given that the map database in format C differs from map databases in the other formats in that the display map data frame is not constituted by defined regions, a geographical range is specified using latitude and longitude in an acquisition request for information for use in map display sent from the basic function unit (53) to the basic logic unit (61).

The data acquisition/modification units (63a-63e) perform merge processing on data extracted from the map database (23), and standardize information that takes account of regional differences (or information that differs regionally). Here, information that takes account of regional differences is, for example, the attributes of links and nodes, with proper names and the like being excluded.

Data that has been extracted from the map database (23) by one of the data acquisition/modification units (63a-63e) and undergone merge processing is sent to one of the data conversion units (65a-65c) corresponding to the data acquisition/modification unit which has extracted the data. The data conversion units (65a-65c) output data received from the data acquisition/modification units (63a-63e) to the basic function unit (53) after respectively performing conversion on the data according to the format of the map database (23) to convert the data to a prescribed data form (or format) common to the data conversion units (65a-65c). Given that the specifications of the formats A, A′ and A″ are largely in common, the three data acquisition/modification units (63a-63c) for formats A, A′ and A″ are compatible with a single data conversion unit (65a). Data conversion units may also be provided for each of formats A, A′ and A″.

Although data is extracted using one of the data acquisition/modification units (63a-63e) according to the format of the map database (23), there are no regional differences in information among data (blocks) received by the data conversion units (65a-65c). Also, although one of the data conversion units (65a-65c) is used according to the format of the map database (23), data including information requested by the basic function unit (53) is passed from the data conversion units (65a-65c) to the basic function unit (53) in a standardized data form. Thus, with the navigation apparatus of the present embodiment, the basic function unit (53), which performs processing related to navigation operations such as map display and route searches, is constituted so as to not be dependent on the format of the map database (23) or the region covered by the map database (23).

The above data form differs depending on the type of information acquisition request sent from the basic function unit (53) to the basic logic unit (61). For example, the data form of data sent from the data conversion units (65a-65c) to the basic function unit (53) in the case where an acquisition request for information required in map display is sent from the basic function unit (53) to the basic logic unit (61) will differ from the case where an acquisition request for information required in a route search is sent. Note that the data form preferably is determined so as to not adversely affect all of the functions intended by the map databases in the various formats (that are provided to the navigation apparatus). For example, given that a format extension is performed in format A′ in order to provide the navigation apparatus with functions that are not obtained in the case where the map database in format A is used, the data form preferably is determined so as to compatible with this extension. The basic function unit (53) preferably is also constituted so as to enable all of the functions intended by the map databases in the various formats to be executed.

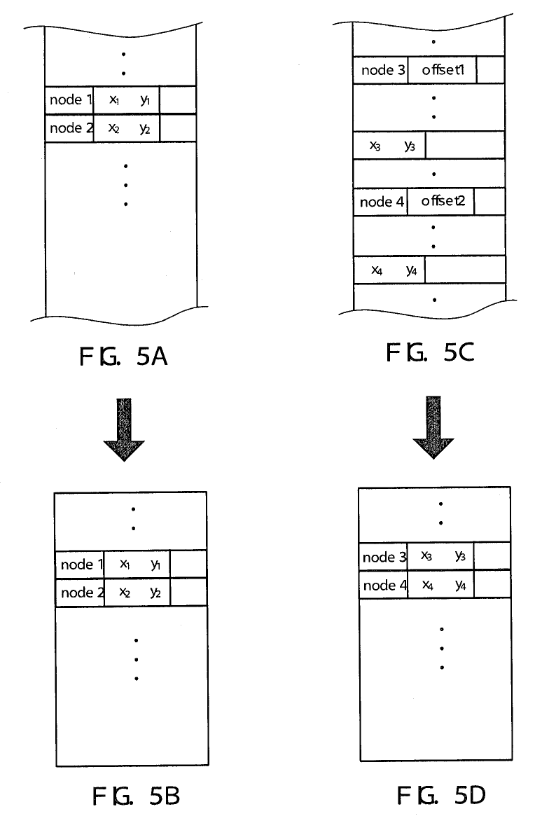

FIG. 5A is an illustrative view schematically showing part of the search data frame in the map database in format A. This search data frame includes information related to nodes whose node IDs are node 1 and node 2, and coordinates and attributes (not shown) related to the nodes with these node IDs. FIG. 5B is an illustrative view schematically showing data converted to the common data form and sent to the basic function unit (53), in the case where the data access unit (55) extracts the part of the search data frame shown in FIG. 5A. With the common data form, node IDs, x-coordinates, y-coordinates, and the attributes of the nodes are placed consecutively. Given that the data placement is similar to the map database in format A, the arrangement of data related to nodes 1 and 2 shown in FIG. 5A is directly reflected in the common data form in FIG. 5B.

FIG. 5C is an illustrative view schematically showing part of the search data frame in the map database in format B. This search data frame includes information related to nodes whose node IDs are nodes 3 and 4 and coordinates and attributes (not shown) related to the nodes with these IDs. With format B, offsets (e.g., provided by a byte count) showing the location of data related to the x-coordinates and y-coordinates of nodes are placed following the node IDs, and the x-coordinate and y-coordinate of the corresponding node are placed in a location remote from the location of the node ID by an amount equal to the size of the offset.

FIG. 5D is an illustrative view schematically showing the configuration of data converted to the common data form and sent to the basic function unit (53), in the case where the part of the search data frame shown in FIG. 5C is read out. The data conversion unit (65b) for format B performs conversion on data sent from the data acquisition/modification unit (63d) so that the node IDs, x-coordinates, y-coordinates, and node attributes are placed consecutively, and passes data in the common form to the basic function unit (53).

The data acquisition/modification units (63a-63e) of the navigation apparatus of the present embodiment function to standardize or eliminate regional differences between map databases usable by the navigation apparatus, by performing merge processing on information included in data extracted from the map database (23). For example, in the case of searching for an optimal route with travel duration as a cost parameter, whether the attribute of the link is “kosokudoro”, “sharyosenyodoro” or “freeway”, the link in the route search will basically be treated in the same way. Consequently, if data in which link attributes and the like have been standardized is passed to the basic function unit (53) in response to the information acquisition request made by the basic function unit (53) in the case of searching for an optimal route with travel duration as a cost parameter, the search unit of the basic function unit (53) can be configured without being affected by the regional differences of the map database (23).

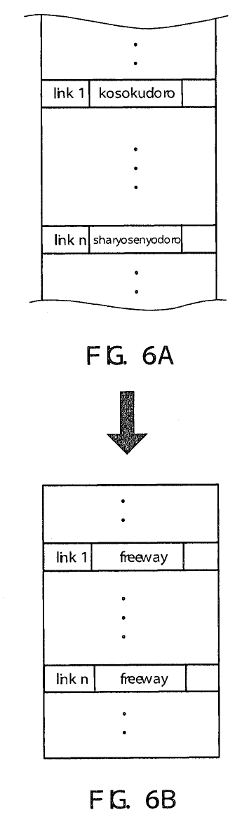

FIG. 6A is an illustrative view schematically showing part of the search data frame in the map database in format A. With the map database in format A, the link attributes are placed after the link IDs. Format A corresponds to Japan, for example, with “kosokudoro” being provided as the attribute of link 1 subsequent to link 1 (link ID), and “sharyosenyodoro” being provided as the attribute of link n subsequent to link n (link ID).

The data acquisition/modification unit (63a) for format A in the navigation apparatus of the present embodiment performs merge processing for standardizing link attributes by changing the attribute of link 1 from “kosokudoro” to “freeway”, and changing the attribute of link n from “sharyosenyodoro” to “freeway”, when data that includes information related to links 1 and n shown in FIG. 6A, for example, is read out from the map database (23) in response to an information acquisition request made by the basic function unit (53) in the case where a route search is executed. In the result, the data block shown in FIG. 6B is passed from the data acquisition/modification unit (63a) to the data conversion unit (65a). Merge processing for eliminating regional differences between the various formats through standardization is also performed as necessary for other link attributes.

This is one example of merge processing preformed by the data acquisition/modification units (63a-63e), and the data acquisition/modification units (63a-63e) also standardize information according to the region covered by the map database (23) on which data extraction is performed for attributes other than link attributes. In the case where the navigation apparatus of the present embodiment is constituted so that a plurality of map databases of different formats covering the same region can be used, merge processing for eliminating regional differences between map databases is not performed, but if there are differences in terminology indicating the attributes of links and nodes, merge processing for standardizing these differences may be performed in the data acquisition/modification units.

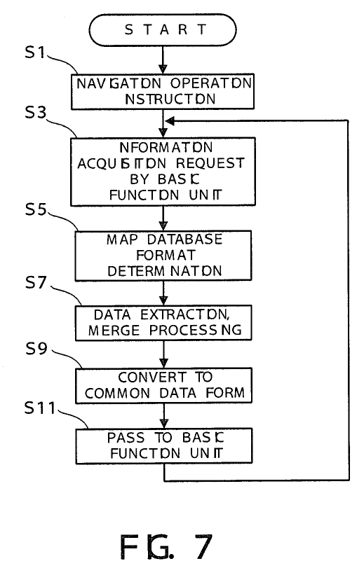

FIG. 7 is a flowchart showing an overview of processing performed as a result of the application software (25) whose overview is shown in FIG. 2 being executed by the control unit (5). Firstly, a request to perform a navigation operation designated by the user via the operation unit (29) is sent from the user interface (51) to the basic function unit (53) (S1). On receiving the request, the basic function unit (53) requests the data access unit (55) for information required in order to perform the designated navigation operation (S3). After step S3, the basic logic unit (61) of the data access unit (55) determines the format of the map database (23), based on the format identifier included in the map database (23) (S5). After step S5, the data acquisition/modification unit (63a-63e) corresponding to the format of the map database (23) extracts data including information requested by the basic function unit (53) from the map database (23), and further performs merge processing (S7). After step S7, data sent from the data acquisition/modification unit (63a-63e) that performed merge processing is converted to the common data form in the data conversion unit (65a-65c) corresponding to the data acquisition/modification unit (63a-63e) (S9), and passed to the basic function unit (53) (S11). After step S11, the steps from step S3 onward are repeated until the processing of the basic function unit (53) related to the designated operation (step S5 is omitted, however) ends. Note that step S5 may be executed first (i.e., prior to S1).

In the foregoing embodiment, the present invention is applied to a vehicle navigation apparatus, but the present invention is not limited to a vehicle navigation apparatus, and may, for example, be applied to a marine navigation apparatus, a mobile navigation apparatus, a mobile telephone having a navigation function, or the like.

The foregoing embodiments have been described in order to describe the present invention, and should not be understood as limiting the invention disclosed in the claims or as restricting the scope of the claims. The constituent elements of the present invention are not limited to the foregoing embodiments, and can, of course, be modified within the technical scope disclosed in the claims.

What is claimed is:

1. A navigation apparatus that executes a navigation operation using information obtained from a map database, comprising:
a basic function unit that performs processing related to the navigation operation; and
a data access unit that, in response to a request from the basic function unit, acquires data including information requested by the basic function unit from the map database, performs conversion on the data acquired from the map database according to the format of the map database to obtain data in a prescribed data form that is not dependent on the format of the map database, and passes the data in the prescribed data form to the basic function unit.

2. The navigation apparatus according to claim 1, wherein the data access unit includes a plurality of data conversion units that correspond one-to-one with a plurality of different formats, determines the format of the map database, converts the acquired data using the data conversion unit corresponding to the determined format to obtain the data in the prescribed data form, and passes the data in the prescribed data form to the basic function unit.

3. The navigation apparatus according to claim 1, wherein the data access unit performs merge processing on information included in the acquired data.

4. The navigation apparatus according to claim 2, wherein the data access unit performs merge processing on information included in the acquired data.
